(19) United States
(12) Patent Application Publication
(10) Pub. No.: US 2026/0254569 A1
(43) Pub. Date: Aug. 27, 2026

(54) HARQ ASSISTANCE INFORMATION FEEDBACK FOR FAST DATA RECOVERY

(71) Applicant: Nokia Technologies Oy, Espoo (FI)

(72) Inventors: Abolfazl Amiri, Aalborg (DK); Klaus Ingemann Pedersen, Aalborg (DK); Troels Emil Kolding, Aalborg (DK); Uyoata Etuk Uyoata, Aalborg (DK)

(21) Appl. No.: 19/489,716

(22) PCT Filed: Jul. 10, 2023
(86) PCT No.: PCT/EP2023/068991

§ 371 Date: Dec. 3, 2025

(51) Int. Cl. H04L 1/1825

(52) U.S. Cl. CPC H04L 1/1825

(57) ABSTRACT

Described herein is a user equipment (UE) configured to support a Hybrid Automatic Repeat Request, HARQ, process when communicating with a network node of a radio access network, the UE comprising at least one processor, and at least one memory storing instructions that, when executed by the at least one processor, cause the UE at least to: establish a connection towards the network node; receive, from the network node, a Transport Block, TB; carry out a Cyclic Redundancy Check, CRC, for decoding the received TB; in case of detecting a failure in the decoding by determining that the received TB fails the CRC check, prepare an assistance information, transmit towards the network node information for indicating the failure and the assistance information for enabling the network node to trigger actions related to the failed TB based on the assistance information, wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE, and wherein the UE is further configured to include information related to at least one determined different transmission parameter in the assistance information.

### TECHNOLOGY

The present disclosure relates to hybrid automatic repeat request, HARQ, process, in particular to feedback provided by the UE to the network side in an HARQ process.

### BACKGROUND

Any discussion of the background art throughout the specification should in no way be considered as an admission that such art is widely known or forms part of common general knowledge in the field.

Current single-bit HARQ feedback information can only carry the information regarding the result of TB (or Code Block, CB, or Code Block Group, CBG) CRC check at the UE. It is true that when the bit is equal to 1, complete information is conveyed and the gNB can move on and remove the correctly transmitted TB from its MAC layer buffer. The main problem comes when the bit is equal to 0 and the message to the gNB is simply “it did not work, try again”. However, at the UE side, there are additional information about the failed CRC's TB that is not communicated to the gNB. For instance, depending to the output of the LDPC decoder, the UE knows how close it was to decode the packet. Such information has been discussed in the literature as soft feedback, where instead of a single-bit feedback, the UE sends a value in the range of [0,1] to show the likelihood of the decoding as in two extremes, 0 means not likely and 1 means definitely. However, there has been significant disagreements on standardizing such a feedback as it would require multiple feedback bits (depending on the quantization function). The introduction of multi-bit feedback for code block group-based transmissions, e.g. for extended reality (XR) use cases where the payloads are large, calls for a rethinking on how to best use multi-bit feedback and with the availability of larger bandwidths which could mean that the network can afford multi-bit HARQ feedback.

On the other hand, for delay sensitive communication, such as XR or ultra reliable-low latency communications (URLLC), the packet delay budget (PDB) values are in the order of a few milliseconds. Thus, relying on the legacy retransmission method may not be desirable. For example, if a TB is received at the UE side but the MCS is far off from the decodable bound, the only response the UE can provide is just to ask for a retransmission of the same TB. However, the UE will not be able to recover the TB, even with several retransmissions since the retransmissions use the same MCS. Afterward, and when the maximum number of retransmissions is reached, the recovery loop from other layers will initiate a new retransmission (with possibly a lower MCS selection at PHY/MAC layer). This process is both time- and radio resource-consuming, and by the time the TB is correctly recovered, the PDB may have been violated.

In view thereof, the present disclosure generally proposes apparatuses (such as UE, DU, CU, or the like) as well as corresponding methods to address some or all of the above-illustrated remarks, particularly in an efficient and flexible manner.

Particularly, in a broad sense, it may be seen that the present disclosure generally seeks to design HARQ assistance information that enables the transmitter-end to better decide how to best proceed with potential HARQ retransmissions to optimize the users' experienced QoS, subject to its QoS constraints (e.g. PDB).

### SUMMARY

In accordance with an aspect of the present disclosure, there is provided a User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
   establish a connection towards the network node;
   receive, from the network node, a Transport Block, TB;
   carry out a Cyclic Redundancy Check, CRC, for decoding the received TB;
   in case of detecting a failure in the decoding by determining that the received TB fails the CRC check, prepare an assistance information,
   transmit towards the network node information for indicating the failure and the assistance information for enabling the network node to trigger actions related to the failed TB based on the assistance information,
   wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE, and
   wherein the UE is further configured to include information related to at least one determined different transmission parameter in the assistance information.

In some examples, a transmission parameter is related to at least one of number of retransmissions, Modulation and Coding Scheme, MCS, New Data Indicator, NDI, type of redundancy, redundancy algorithm, rank.

In some examples, the transmission parameter is related to number of retransmissions, MCS and NDI, and the UE is further caused to:
indicate the network node, via the assistance information, to carry out the calculated estimated number of required retransmissions with an initial MCS used for the failed transmission of the TB,
wherein the NDI indicates that a copy of the failed transmission of the TB is to be transmitted by the network node.

In some examples, the transmission parameter is related to number of retransmissions, MCS and NDI, and the UE is further caused to:
based on a preconfigured function, determine a number of required retransmissions to be carried out by the network node with a target MCS different from an initial MCS used for the failed transmission of the TB,
   wherein the preconfigured function comprises input parameters including a decoding analysis result, the initial MCS and the target MCS, wherein the UE is configured to determine the decoding analysis result based on the SINR measurements; and
indicate the network node, via the assistance information, to carry out the determined number of required retransmissions with the target MCS,
wherein the NDI indicates that a copy of the failed transmission of the TB is to be transmitted by the network node.

In some examples, the transmission parameter is related to number of retransmissions, NDI and at least one of MCS, type of redundancy and redundancy algorithm, wherein the UE is configured with a maximum allowed number of retransmissions, and the UE is further caused to:
if the calculated estimated number of required retransmissions of the failed TB exceeds the maximum allowed number of retransmissions, indicate the network node, via the assistance information, to carry out a new transmission for the failed TB with a new type of redundancy different from an initial type of redundancy used for the failed transmission of the TB and/or with a new MCS different from an initial MCS used for the failed transmission of the TB and/or with a new redundancy algorithm different from an initial redundancy algorithm used for the failed transmission of the TB,
wherein the NDI indicates that new data related to the failed TB is to be transmitted by the network node.

In some examples, the transmission parameter is related to rank and NDI, and the UE is further caused to:
based on a decoding analysis result related to the failed TB, the decoding analysis result comprising the SINR measurements, determine a new rank different from an initial rank used for the failed transmission of the TB, and indicate the network node, via the assistance information, to carry out transmission with the determined new rank; or
indicate the network node, via the assistance information, to determine a new rank different from and preferably lower than the initial rank and to carry out transmission with the determined new rank,
wherein a rank indicates a number of streams of data to be received with the same number of receiving antennas at the UE,
wherein the NDI indicates either new data related to the failed TB to be transmitted by the network node or a copy of the failed transmission of the TB to be transmitted by the network node.

In some examples, the UE is further caused to:
measure an SINR value for the received and failed TB;
calculate a difference between a preset decodable SINR value and the measured SINR value; and
based on the calculated difference value, calculate the estimated number of required retransmissions of the failed TB by the network node.

In some examples, the received TB comprises a plurality of Code Block Groups, CBGs, wherein the UE is further caused to:
if determining that at least one of the plurality of CBGs fails the CRC check, determine that the received TB fails the CRC check; and
transmit the assistance information to the network node for the at least one failed CBG.

In some examples, the assistance information comprises an information element comprising two bits indicating four cases, wherein:
in a first case, the two bits indicate an Acknowledgement, ACK, to the network node, a successful decoding of the received TB and that no retransmissions of the received TB are required;
in a second case, the two bits indicate that one retransmission is required for the failed TB;
in a third case, the two bits indicate that a number of required retransmissions for the failed TB is smaller than or equal to a maximum number of allowed retransmissions for the failed TB allowed at the UE; and
in a fourth case, the two bits indicate a new transmission for the failed TB.

In some examples, the UE is further caused to transmit the assistance information via an Uplink Channel Information, UCI.

In accordance with another aspect of the present disclosure, there is provided a network node of a radio access network, configured to support a hybrid automatic repeat request, HARQ, process when communicating with a User Equipment, UE, the network node comprising:
at least one processor, and
at least one memory storing instructions that, when executed by the at least one processor, cause the network node at least to:
   establish a connection towards the UE;
   transmit, to the UE, a transport block, TB;
   receive, from the UE, information for indicating a failure in decoding the TB at the UE and an associated assistance information prepared by the UE, wherein the assistance information includes information related to a transmission parameter different from a corresponding transmission parameter used for the transmission of the failed TB and trigger actions related to the failed TB based on the assistance information for supporting successful decoding of said TB at the UE.

In some examples, the network node is further caused to transmit to the UE a resource radio control, RRC, message for configuring the assistance information and for indicating the UE to send to the network node the assistance information in case of a failure in decoding the TB at the UE.

In some examples, the network node is configured to perform transmission related to the failed TB with at least one transmission parameter indicated by the UE via the assistance information, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE.

In some examples, a transmission parameter is related to at least one of number of retransmissions, Modulation and Coding Scheme, MCS, New Data Indicator, NDI, type of redundancy, redundancy algorithm, rank.

In some examples, the assistance information indicates to carry out a calculated estimated number of retransmissions for the failed TB with an initial Modulation and Coding Scheme, MCS, used for the failed transmission of the TB, wherein the network node is further caused to:
if determining that a time needed for carrying out the calculated estimated number of retransmissions does not exceed a preset delay budget, carry out the estimated number of retransmissions for the failed TB with the initial MSC.

In some examples, the assistance information indicates to carry out a required number of retransmissions for the failed TB with a target MCS different from an initial MCS used for the failed transmission of the TB, wherein the network node is further caused to:
if determining that a time needed for carrying out the required number of retransmissions does not exceed a preset delay budget, carry out the required number of retransmissions for the failed TB with the target MCS.

In some examples, the assistance information indicates to carry out a new transmission for the failed TB with a new MCS different from an initial MCS used for the failed transmission of the TB, wherein the network node is further caused to:
carry out a new transmission for the failed TB with the new MCS, or
select a modified new MCS with an index lower than the indicated new MCS and carry out a new transmission for the failed TB with the modified new MCS.

In some examples, the assistance information indicates to carry out a new transmission for the failed TB with a new type of redundancy different from an initial type of redundancy used for the failed transmission of the TB and/or with a new redundancy algorithm different from an initial redundancy algorithm used for the failed transmission of the TB, wherein the network node is further caused to:
carry out a new transmission for the failed TB with the new type of redundancy; and/or
carry out a new transmission for the failed TB with the new redundancy algorithm.

In some examples, the assistance information indicates to carry out transmission for the failed TB with a new rank different from an initial rank used for the failed transmission of the TB, wherein the network node is further caused to:
carry out transmission for the failed TB with the new rank, or
select a modified new rank with an index lower than the indicated new rank and carry out transmission for the failed TB with the modified new rank.

In accordance with yet another aspect of the present disclosure, there is provided a system, configured for performing a hybrid automatic repeat request, HARQ, process, the system comprising:
a User Equipment, UE, in accordance with any one of the examples related to the above aspect related to the UE; and
a network node in accordance e.g., with any one of the examples related to the above aspect related to the network node.

In accordance with yet another aspect of the present disclosure, there is provided a method of a User Equipment, UE, configured to support a Hybrid Automatic Repeat Request, HARQ, process when communicating with a network node of a radio access network, the method comprising:
establishing a connection towards the network node;
receiving, from the network node, a Transport Block, TB;
carrying out a Cyclic Redundancy Check, CRC, for decoding the received TB;
in case of detecting a failure in the decoding by determining that the received TB fails the CRC check, preparing an assistance information,
transmitting towards the network node information for indicating the failure and the assistance information for enabling the network node to trigger actions related to the failed TB based on the assistance information,
wherein the method further comprises, in case of detecting the failure, determining at least one transmission parameter based on Signal-to-Interference plus Noise Ratio, SINR, measurements performed by the UE, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE, and
wherein the method further comprises including information related to at least one determined different transmission parameter in the assistance information.

In accordance with yet another aspect of the present disclosure, there is provided a method of a network node of a radio access network, configured to support a hybrid automatic repeat request, HARQ, process when communicating with a User Equipment, UE, the method comprising:
establishing a connection towards the UE;
transmitting, to the UE, a transport block, TB;
receiving, from the UE, information for indicating a failure in decoding the TB at the UE and an associated assistance information prepared by the UE, wherein the assistance information includes information related to a transmission parameter different from a corresponding transmission parameter used for the transmission of the failed TB and triggering actions related to the failed TB based on the assistance information for supporting successful decoding of said TB at the UE.

In accordance with yet another aspect of the present disclosure, there is provided a computer program comprising instructions for causing an apparatus to perform the above methods.

In accordance with yet another aspect of the present disclosure, there is provided a memory storing computer readable instructions for causing an apparatus to perform the above methods.

In accordance with yet another aspect of the present disclosure, there is provided a User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
   establish a connection towards the network node;
   receive, from the network node, a Code Block, CB;
   carry out a Cyclic Redundancy Check, CRC, for decoding the received CB;
   in case of detecting a failure in the decoding by determining that the received CB fails the CRC check, prepare an assistance information,
   transmit towards the network node information for indicating the failure and the assistance information for enabling the network node to trigger actions related to the failed CB based on the assistance information,
   wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed CB, and wherein one transmission parameter is, in particular, related to a calculated estimated number of retransmissions required for a successful decoding of said CB at the UE, and
   wherein the UE is further configured to include information related to at least one determined different transmission parameter in the assistance information.

In accordance with yet another aspect of the present disclosure, there is provided a User Equipment, UE, configured to support a Hybrid Automatic Repeat Request, HARQ, process when communicating with another user equipment, the UE comprising:
at least one processor, and
at least one memory storing instructions that, when executed by the at least one processor, cause the UE at least to:
   establish a radio connection towards the another user equipment via a direct link using device-to-device communication or sidelink communication;
   receive, from the another user equipment, a Transport Block, TB, and/or a Code Block, CB;
   carry out a Cyclic Redundancy Check, CRC, for decoding the received TB and/or CB;
   in case of detecting a failure in the decoding by determining that the received TB and/or CB fails the CRC check, prepare an associated assistance information, transmit towards the another user equipment information for indicating the failure and the assistance information for enabling the another user equipment to trigger actions related to the failed TB and/or CB based on the associated assistance information,
   wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB and/or CB, and wherein one transmission parameter is, in particular, related to a calculated estimated number of retransmissions required for a successful decoding of said TB and/or CB at the UE, and
   wherein the UE is further configured to include information related to at least one determined different transmission parameter in the assistance information.

In accordance with yet another aspect of the present disclosure, there is provided a User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
   establish a connection towards the network node;
   receive, from the network node, a UE capability request,
   send, towards the network node, a UE capability information including the UE's capability to support sending assistance information in case of detecting a failure in decoding a received data packet, wherein a data packet, in particular, includes a Transport Block, TB, and/or a Code Block, CB,
   receiving, from the network node, a configuration message including, in case the UE supports sending the assistance information, a configuration related to the use of the assistance information,
   in case of detecting a failure in the decoding of a received data packet, prepare an associated assistance information based on the configuration,
   transmit, towards the network node, information for indicating the detected failure and the associated assistance information for enabling the network node to trigger actions related to the failed data packet based on the assistance information,
   wherein the UE is further configured to include information related to at least one transmission parameter different from a corresponding transmission parameter used for the transmission of the failed data packet in the assistance information.

Furthermore, according to some example embodiments, there is provided a UE comprising respective suitable means configured for performing the respective steps as disclosed in the present disclosure.

Furthermore, according to some example embodiments, there is provided a network node comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

The invention/use of assistance information is applicable in different circumstances, e.g. in accordance with one of the examples mentioned, with two or more of the examples combined, or in case of other examples, thus e.g. independent of the listed ones.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a high level block diagram of data flow chart for an example of multiplexing several IP packets from different RBs into one MAC PDU which later is scheduled into one TB;

FIG. 2 schematically illustrates an example of a signaling/messaging diagram according to an example embodiment of the present disclosure; and

FIG. 3 schematically illustrates an example of a signaling/messaging diagram according to an example embodiment of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/CRAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

This application is related to use of more detailed hybrid automatic repeat request (HARQ) response in order to avoid wasting retransmission resources. In fact, with current standards for the HARQ response (e.g. 3GPP TS38.321 V17.3.0 (2022-12) section 5.3.2), the UE is allowed to send a single bit (1: ACK or 0: NACK), to inform the gNB of the result of the reception of a certain transport block (TB). At the UE side, depending on the output of the Cyclic Redundancy Check (CRC check), the feedback is generated and reported to the gNB. One general shortcoming of using the single-bit feedback is that it omits additional information regarding the decodeability of a TB transmission. In other words, if the gNB receives a NACK bit as the HARQ feedback, there is only limited guidance to let the gNB know how to proceed. More information could give guidance to different questions, for instance:
1. How many additional retransmissions are required (with the same modulation and coding scheme (MCS)), so the UE can decode the TB?
2. Should the gNB use a different MCS for the retransmissions? For example, either the gNB should start over or use incremental redundancy.
3. Should the gNB use additional redundancies to help with the UE TB decoding? For instance, change of channel coding scheme from LDPC to polar codes or any other scheme.

Thus, there is a need to propose a new method where the simple HARQ feedback is complemented with assistance information to guide the gNB towards a better data recovery strategy.

Before going into detail of the example embodiments of the present disclosure, it may also be worthwhile to provide a brief description-from a high/abstract level perspective-that could serve as a basis for understanding possible underlying technologies (and the terminologies used therein) that are described in the present disclosure. However, as has been indicated above, the techniques described in the present disclosure may be applicable to some other possible technologies, for example with suitable/appropriate adaptation wherever necessary, as can be understood and appreciated by the skilled person.

References are now made to the figures. In particular, it is to be noted that identical or like reference numbers used in the figures of the present disclosure may, unless indicated otherwise, indicate identical or like elements, such that repeated description thereof may be omitted for reasons of conciseness.

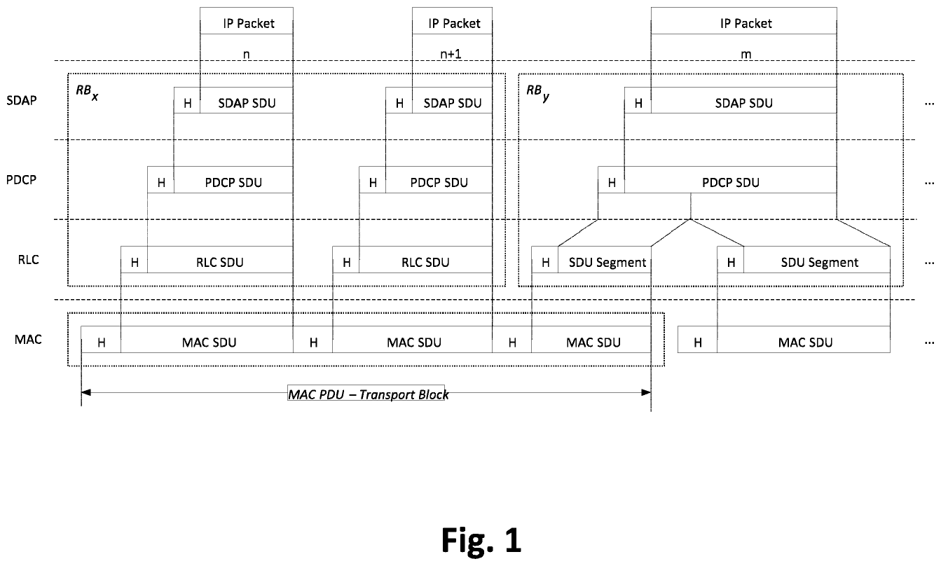

FIG. 1 schematically illustrates an example of a high-level block diagram of data flow chart for an example of multiplexing several IP packets from different RBs into one MAC PDU which later is scheduled into one TB. This figure is in accordance with 3GPP TS 38.300 V17.3.0 (2022-12) section 6.6.

The current 5G NR specifications include options for multiplexing different IP packets, and data from different RBs into one MAC PDU as pictured in Error! Reference source not found. (see e.g. the overview in 3GPP TS 38.300 V17.3.0 (2022-12), section 6.6). Prior to the actual transmission of MAC PDU in one transport block on the downlink physical-layer, the following processing steps happen:
1. Transport block CRC attachment;
2. Code block segmentation and code block CRC attachment;
3. Channel coding: LDPC coding;
4. Physical-layer hybrid-ARQ processing;
5. Rate matching;
6. Scrambling;
7. Modulation: QPSK, 16QAM, 64QAM, 256QAM, and 1024QAM;
8. Layer mapping;
9. Mapping to assigned resources and antenna ports.
   Options with CBG-based HARQ transmission are also supported by 5G NR. CBG-based transmissions are e.g. specified in Section 5.1.7 of 3GPP TS 38.214 V17.3.0 (2022-12), entitled “Code block group based PDSCH transmission”. Details of HARQ feedback for CBG based transmissions are e.g. specified in 3GPP TS 38.213 V17.3.0 (2022-12), section 9.1.1 entitled “CBG-based HARQ-ACK codebook determination”. Aspects of CBG-based transmissions also appear in e.g. the MAC specification (3GPP TS 38.321 V17.3.0 (2022-12)). The basic principle is that the TB is organized into multiple CBs. The maximum size of a CB is 8448 bits. The CBs are grouped into CBGs. For each received TB, the receiver provides feedback to indicate which CBGs are in error, and only the erroneously received CBGs are thereafter retransmitted by the transmitter. For transmission of large TB sizes (for example, as is the case for XR use cases as defined in 3GPP TR 38.838 V17.0.0 (2021-12)) such techniques are promising. Cases with up to 8 CBGs per TB are supported by current NR specs. More generally, the maximum number of CBGs per TB is configurable as C E {2, 4, 6, 8} for the PDSCH.

The Physical Downlink Control Channel (PDCCH) is used to schedule DL transmissions on PDSCH and UL transmissions on PUSCH, where the Downlink Control Information (DCI) on PDCCH e.g. includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

Notice that there is one DL scheduling grant per UE, per carrier and codeword only, and that it includes one modulation and coding format (also known as MCS). The DCI format for DL scheduling on the PDSCH that supports CBG transmission is Format 1_1 (see details in 3GPP TS 38.212 and 38.214). There, CBG Transmission Information (CBGTI) field determines the number of CBGs per TB and then the CBs will be assigned into C (e.g. C∈{2, 4, 6, 8}) groups.

In this application it is proposed to use the information that is available at the UE side after trying to decode a TB, to provide assistance information to guide the gNB on how to proceed with the HARQ process.

One main innovative step is to prepare assistance information if the first transmission fails, and signal it to the network. This information can be in one or more of the following types (different, separate options which may be combined with each other in total or in part):
1. Inform the gNB how many retransmissions (denoted N) with the same MCS index (e.g., the same as that used in the initial transmission of the TB which the UE fails to decode) would be required to reach correct decoding.
2. Indication to the gNB that guides it to start with a new transmission with a different MCS index (e.g., different from that used in the initial transmission of the TB which the UE fails to decode).
3. Repeat the transmission N times with a different MCS index (e.g., different from that used in the initial transmission of the TB which the UE fails to decode) as this is estimated to be the best.
4. Use a different type of redundancy than the current one (e.g., different from that used in the initial transmission of the TB which the UE fails to decode). Alternatively or additionally, a different redundancy algorithm may be used.
5. Indicate the rank for which the retransmission should be sent. A rank may also be determined and indicated for a new transmission.

The assistance information can be signalled via UCI in UL to guide gNB on how to proceed with the rest of the retransmissions.

In this application, retransmission refers to that the transmitter sends an exact copy of the first (initial) transmission which has failed; however, a new transmission can be different from the initial transmission (possibly different characteristics such as different modulation and coding, etc.). There is another difference in terms of the ability of the receiver to combine the initial failed TB with the (re/new)-transmissions. Legacy receivers can only combine information if a retransmission (same MCS) is sent as it is an exact copy and signals can be summed. This is not the case for a new transmission, for which the receivers can combine new transmissions, i.e., new TBs (with different MCS) with the initial TB (option 3 above).

Whether a retransmission or a new transmission is to be performed by the transmitter (i.e., the network node) can be indicated by a New Data Indicator (NDI). For instance, NDI set to 1 indicates new transmission and set to 0 indicates retransmission. If the NDI is set to 1, the UE can flush the first failed TB from its memory and start over with a fresh TB configuration.

To summarize the above options, the UE is configured to, in case of detecting a failure of decoding a received TB, determine at least one transmission parameter (e.g., based on Signal-to-Interference plus Noise Ratio, SINR, measurements performed by the UE), preferably at least one determined transmission parameter being different from a corresponding transmission parameter used for the transmission of the failed TB. One transmission parameter is, in particular, related to a calculated estimated number of retransmissions required for a successful decoding of said TB at the UE, wherein the UE is further configured to include information related to at least one determined different transmission parameter in the assistance information. Therein, a (to-be-determined, preferably different) transmission parameter is related to at least one of the following: number of retransmissions, Modulation and Coding Scheme (MCS), New Data Indicator (NDI), type of redundancy, redundancy algorithm and rank. Therein, the calculated number of retransmissions is an integer larger than 1, and could e.g. be 2, 3, 4, . . . , n. For instance, if the UE indicates 4 to gNB, then gNB may select 4 consecutive retransmissions, and e.g. only after the fourth received retransmission the UE sends an ACK or NACK to gNB.

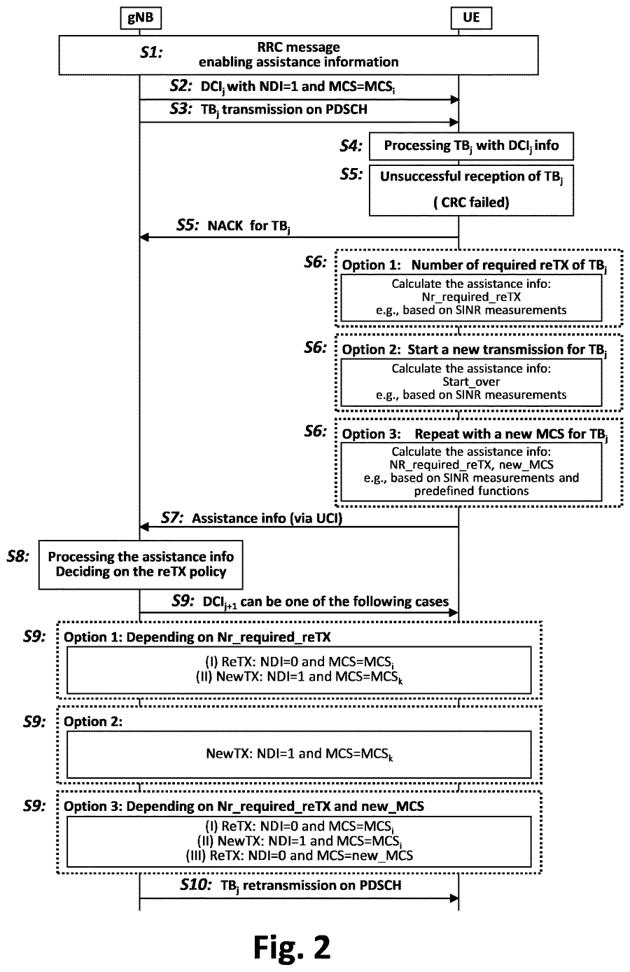

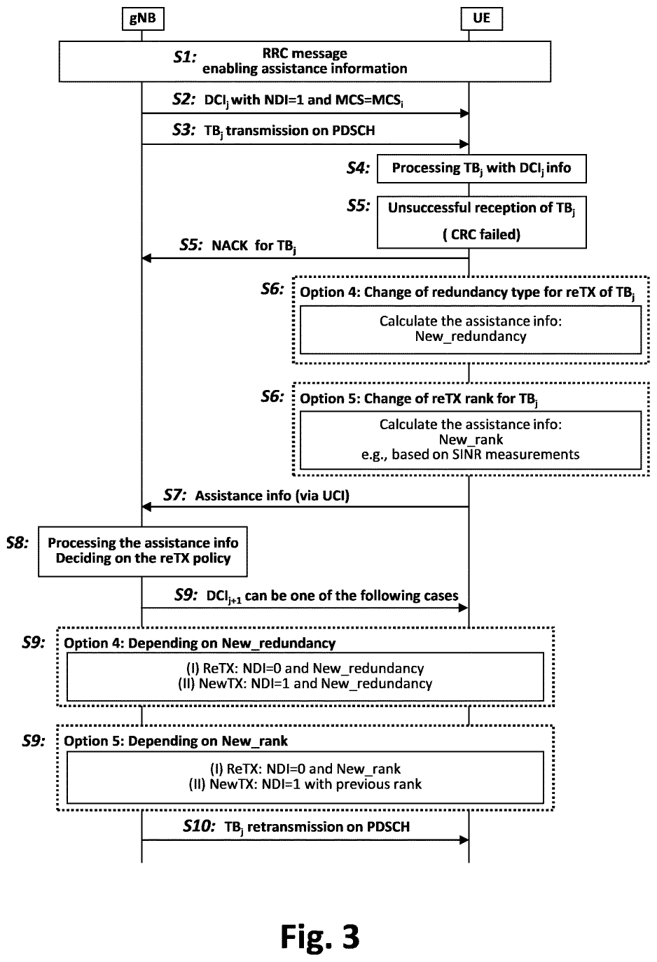

FIGS. 2 and 3 show a signalling diagram of the proposed idea. FIG. 2 is illustrating the first 3 options, while FIG. 3 is showing the case with options 4 and 5 listed above.
Step S1: the gNB sends an RRC message to configure the new assistance information:
   1. Assistance information is enabled for each unsuccessful TB.
   2. Format of which assistance information to be provided is configured as the UE can send: Number of required retransmissions (reTX), new MCS for the retransmissions, new MCS for the new transmissions, new type of redundancy, new redundancy algorithm, different preferred rank, different channel coding scheme or any other additional information.
   Then, during the established connection, UE knows that in case of NACK it has to send the assistance information specified via the RRC message earlier.
Step S2: The gNB sends a scheduling DCI for TBⱼ where new data indicator (NDI) is 1 and MCS index is MCSᵢ, together with other scheduling information.
Step S3: The gNB transmits the scheduled TBj on PDSCH channel.
Step S4: The UE receives the TB and tries to decode it based on DCI's content.
Step S5: In case of an unsuccessful reception (TB; fails the CRC check): The UE sends a NACK message (as legacy).
Step S6: The UE calculates the assistance information (based on RRC configurations or any other session setup information from the network). This information could be in a form of asking the gNB to (carry out at least one of the following options):
   1. Repeat the transmission N more times with the same MCS index. (see FIG. 2)
   2. Start a new transmission (of TBⱼ) with a different MCS index. (see FIG. 2)
   3. Repeat the transmission N more times with a different MCS index. (see FIG. 2)
   4. Use a different type of redundancy and/or a different redundany algorithm than the current one. (see FIG. 3)
   5. Indicate the rank for which the retransmission or a new transmission should be sent on. (see FIG. 3)
      Corresponding UE procedures for each of the options is explained in UE procedures for Step S6.
Step S7: The UE sends the calculated information in UL (for instance using UCI).
Step S8: The gNB processes the assistance information and decides how to proceed with the retransmissions.
   1. The gNB can choose to follow the UE's recommendation and alternate the legacy retransmission scheme. The gNB can use the information to for instance estimate how many reTXs it would take to reach a successful reception. More information regarding gNB procedures is discussed in gNB procedures for Step S8.
   2. The gNB can choose to ignore the UE's recommendation and follow the legacy HARQ retransmission protocol or any other vendor specific strategy.
Step S9: The gNB sends a new DCI for the retransmission that can follow one of the below cases:
   1. (The gNB ignores UEs recommendation) same as legacy, retransmission with the case MCS index.
   2. The gNB schedules several TB retransmissions of the failed TB (based on UE's assistance information), with the same MCS index. The gNB may also schedule each of the retransmission TBs separately each with a new DCI. (see FIG. 2)
   3. The gNB starts a new transmission of the same TB with a different MCS index. (see FIG. 2)
   4. The gNB continues the retransmissions but changes the MCS index to lower indices. This option requires more complex UE receivers that can combine TBs with different MCS indices. (see FIG. 2)
   5. The gNB changes the redundancy type and/or the redundancy algorithm based on the UE's assistance. (see FIG. 3)
   6. The gNB can increase or decrease the rank based on UEs guidance. (see FIG. 3)
Step S10: The gNB transmits the TB based on the information provided by the DCI.
Step S11 (not shown in FIGS. 2 and 3): In case of the successful reception: The UE sends an ACK message (as legacy).

### UE Procedures for Step S6

For each of the 5 options mentioned in step S6, the UE may follow the following procedure:
a) The UE measures the experienced SINR for the transmission of TBⱼ (Sⱼ).
b) The UE compares Sⱼ with its own predefined decodable SINR value (S_{D}), and calculates the SINR difference as Sᵣₑₜₓ=S_{D}−Sⱼ
   Remark: The UE can also use other sources to determine the quality of the received failed TB such as the output of the TB decoder function. For instance, for 5G NR, the output of the low-density parity check (LDPC) decoder that gives a measure on how close is the receiver to fully decode the TB can be used.
c) The UE may use a predefined function to calculate the number of required retransmissions. This can be simply achieved via

$${N}_{retx} = ceil ( {10}^{\frac{{s}_{r e t x}}{10}} ) - 1 ,$$

where ceil stands for the ceiling function. This function simply comes from the retransmission gain for each time that increases the aggregated SINR at the receiver. Use of any other function is not prohibited.

Now, for each of the 5 options mentioned in step S6, the UE may continue as the following:
Option 1) The UE may send Nᵣₑₜₓ as it is to indicate the number of estimated required retransmissions to fully recover a TB.
Option 2) For this option, the UE may be configured with a maximum number of possible retranmissions Nₘₐₓ. Next, if Nᵣₑₜₓ>Nₘₐₓ, the UE may simply ask to start a new transmission with one lower index than the first transmission's MCS index. In one embodiment, starting a new transmission can happen in the MAC layer. In another embodiment this indication can trigger an early RLC layer ARQ to initiate a new transmission. Nₘₐₓ can be sent via gNB to the UE via semi-static signalling (for example RRC message) for each of the HARQ processes.
Option 3) This option is for more advanced receivers where combining of TBs with different sizes and MCS values is possible for instance via combining of soft-output of the decoders. The UE may use a preconfigured function F, to figure out the number of required reTX in a different MCS. For instance, the UE can use Nᵣₑₜₓ=F (Sᵣₑₜₓ, MCS₁, MCS₂), where MCS₁ and MCS₂ are the initial and target MCS indices, respectively. For this example, the UE will signal Nᵣₑₜₓ and MCS₂ values.
Option 4) This option is for more advanced transceivers where several redundancy type functionalities are available in both the gNB and the UE. This can be seen as an extension to option 2, where when Nᵣₑₜₓ>Nₘₐₓ happens, the UE may ask for a different redundancy scheme (redundancy type, redundancy algorithm) that provides a better reliability target. For instance, the UE may ask the gNB to use incremental redundancy instead of CHASE combining. Additionally or alternatively, the UE indicates the gNB to use a different MCS. Additionally or alternatively, the UE indicates the gNB to use a different coding scheme.
Option 5) For this case, the UE may use a combination of the calculations done for the other options to calculate the rank for which the retransmission should be done so the combined received SINR can reach to S_{D}. The determination of new rank is depending on UE implementation. One method could be to calculate the SINR from each of the receiving antenna ports and determining that by combining signal from how many antennas, the SINR can reach a threshold where the TB can be decoded. To give an example, assume the initial transmission is with rank 4 (or 4 different streams of data to be received with 4 RX antennas), however, the UE (in case of failure) can calculate that if the transmission was with rank 2 (only 2 streams of data each received with a pair of antennas that gives a better SINR), the TB would have been decoded successfully. Therefore, the UE would ask the gNB to send the retransmission with rank 2.

### gNB Procedures for Step S8

In the following, it is listed the possible procedure at the gNB based on the received assistance information provided by the UE.
1. No action mode: The gNB ignores the UE recommendations and continues to follow the legacy procedures.
2. Action mode: In this case the gNB considers the UE recommendation to adjust the HARQ procedure. For each of the above-mentioned assistance information options, the gNB can react accordingly as the following:
   Option 1) It can use Nᵣₑₜₓ to determine if this many retransmissions are possible within the delay budget of the ongoing service and if yes, it can start scheduling them. The scheduling can be done with one DCI per transmission or a multi-PDSCH transmission with a single DCI. Otherwise, it can directly choose to start a new transmission to meet the latency target for instance. The gain from this option is that the PDB considerations can be taken into account to make sure the TBs will actually delivered correctly in time.
Option 2) If the UE asks for a new transmission, the gNB can simply initiate it with a new DCI and can either choose the recommended MCS by the UE (one lower index than the initial transmission) or choose even lower indices to increase the reliability. This can significantly reduce the capacity waste due to several failed retransmissions that could have happened with the legacy implementation.
Option 3) This option can be seen as an extension for Option 1, where the solution is a bit more complex (change of MCS), but it provides better spectral efficiency.
Option 4) Similar to the case of Option 2, the gNB starts a new transmission with a different redundancy type to fulfill reliability/latency requirements. This options provides better spectral efficiency as compared to legacy solution.
Option 5) The change of transmission rank can happen in two ways: 1. If the UE specifies the desired rank for retransmissions, the gNB can use that number or any number lower than that rank. 2. If the UE only asks to lower the rank, the gNB may use other measurement data to find the best possible rank for the retransmission (gNB implementation specific).

### ADDITIONAL EMBODIMENTS

The above solution is easily applicable for the CBG based transmission and HARQ feedback, as the case of scenario 1: TB passes the CRC check, translates into all CBGs pass the CRC check. Similarly, the case of scenario 2: TB fails the CRC check, translates into, at least one CBG fails CRC check. For the CBG based transmission, the UE's assistance information for scenario 1 is for all the CBGs and for the second scenario for the failed CBGs.

In one embodiment the assistance information is encoded separately than the legacy ACK/NACK response. In another embodiment, optimizing of the signaling by integrating the HARQ response with the soft information can be done. For example, a 2 bit case of is shown below where the signaling element is equal to the remaining required reTX as:
00=ACK/no reTX is required
01=1 reTX is required
10=within configured max number of reTx
11=Inf or ask gNB to start over

Similarly, other versions with more bits capturing more levels of assistance information can be designed and reported.

In summary, the solution proposed in this application comprises the following main innovative steps:
Configuring the UE to send assistance information to guide the gNB in the retransmission process.
Configuring the UE to send assistance information to guide gNB for the future transmissions even if the TB transmission was successful.
Proposing several options for the assistance information that can be used at the gNB.

The following technical advantages are provided in accordance with the solution proposed in this application:
in particular, for the NACK case:
Option 1: Fast determination of the required reTX can help gNB to see if the transmissions can make it within the PDB (if any) and prioritize the scheduling to meet the targets. It can also save signalling overhead if the gNB decides to schedule all the retransmission with multi slot scheduling (multi PDSCH).
Options 2, 4 and 5: Early termination of a ‘going to be failed’ process can help reducing the unnecessary retransmission with a wrong MCS that can boost the spectral efficiency and reduce the end to end latency. In particular, option 4 is more general than just changing the redundancy version, instead, it is recommended changing the type of redundancy (CHASE combining or incremental redundancy) and even change of the redundancy algorithm (such as changing the FEC from LDPC to Polar or any other type of encoding/decoding functionalities available at the gNB and the UE.
Option 3: Similar to the above case, choice of a proper MCS as soon as possible can help reducing unnecessary retransmissions and save in latency and downlink capacity.

It is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

Inventive technical features in the above-illustrated example embodiments may also be combined with or applicable to at least one of the following further embodiments, which e.g. relate to Code Block, CB, device-to-device communication or sidelink communication, UE capability and assistance configuration, and/or multicast. In general, in systems in which HARQ processes are used. Parts of the embodiments might be combined.

In a further embodiment related to Code Block, CB, a UE may be described as follows:
A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a Code Block, CB;
carry out a Cyclic Redundancy Check, CRC, for decoding the received CB;
in case of detecting a failure in the decoding by determining that the received CB fails the CRC check, prepare an assistance information,
transmit towards the network node information for indicating the failure and the assistance information for enabling the network node to trigger actions related to the failed CB based on the assistance information,
wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed CB, and wherein one transmission parameter is, in particular, related to a calculated estimated number of retransmissions required for a successful decoding of said CB at the UE, and
wherein the UE is further configured to include information related to at least one determined different transmission parameter in the assistance information.

In general, e.g. 3GPP TS 38.300 V17.3.0 (2022.12) section 6.2.4 describes HARQ-TB relationship: The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

Further, section 5.2.2 exemplarily describes the CRC attachment or both TB and CB: Physical-layer processing for physical downlink shared channel.

The downlink physical-layer processing of transport channels consists of the following steps:
Transport block CRC attachment;
Code block segmentation and code block CRC attachment;
Channel coding: LDPC coding.

The principles of assistance information determination are applicable to both TB and CB, e.g. as both have their own CRC and if a CRC check determines a failure an associated assistance information can be generated. The gNB is e.g. configured to determine or configure the UE regarding use of the assistance information, e.g. UE to generate assistance information on TB level, e.g. one assistance information generation if at least one failed CB has been identified and transmit the assistance info together with the NACK of the TB. Or, e.g. generate and send assistance information for the first failed CB and together with the NACK of the CB (or CBG), but not for additional failed CBs of a TB to reduce overhead and redundancy.

Such a UE may then be implemented in the environment of FIGS. 2 and 3.

In a further development related to device-to-device communication or sidelink communication, a UE may be described as follows:
A User Equipment, UE, configured to support a Hybrid Automatic Repeat Request, HARQ, process when communicating with another user equipment, the UE comprising:
at least one processor, and
at least one memory storing instructions that, when executed by the at least one processor, cause the UE at least to:
establish a radio connection towards the another user equipment via a direct link using device-to-device communication or sidelink communication;
receive, from the another user equipment, a Transport Block, TB, and/or a Code Block, CB;
carry out a Cyclic Redundancy Check, CRC, for decoding the received TB and/or CB;
in case of detecting a failure in the decoding by determining that the received TB and/or CB fails the CRC check, prepare an associated assistance information,
transmit towards the another user equipment information for indicating the failure and the assistance information for enabling the another user equipment to trigger actions related to the failed TB and/or CB based on the associated assistance information,
wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB and/or CB, and wherein one transmission parameter is, in particular, related to a calculated estimated number of retransmissions required for a successful decoding of said TB and/or CB at the UE, and
wherein the UE is further configured to include information related to at least one determined different transmission parameter in the assistance information.

According to 3GPP TS 38.300 V17.3.0 (2022-12) section 5.7 exemplary Sidelink processes are detailed:

Sidelink supports UE-to-UE direct communication using the sidelink resource allocation modes, physical-layer signals/channels, and physical layer procedures below.

Two sidelink resource allocation modes are supported: mode 1 and mode 2. In mode 1, the sidelink resource allocation is provided by the network. In mode 2, UE decides the SL transmission resources in the resource pool(s).

Physical Sidelink Control Channel (PSCCH) indicates resource and other transmission parameters used by a UE for PSSCH. PSCCH transmission is associated with a DM-RS.

Physical Sidelink Shared Channel (PSSCH) transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.

The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended CP cases respectively, including the associated DM-RS.

Sidelink HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In sidelink resource allocation mode 1, a UE which received PSFCH can report sidelink HARQ feedback to gNB via PUCCH or PUSCH.

In addition to the sidelink HARQ feedback the assistance information may be included. Dependent on the configuration a dedicated resource is allocated to transmit NACK and assistance information.

Such a UE may then be implemented in the environment of FIGS. 2 and 3.

In a further development related to UE capability and assistance configuration a UE may be described as follows:

Such a UE may then be implemented in the environment of FIGS. 2 and 3.

In a further development related to multicast and/or transmission on PUCCH or PUSCH a UE may be described as follows:

In general, e.g. 3GPP TS 38.300 V17.3.0 (2022-12) section 7.2 describes protocol sates including RRC_CONNECTED:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Transfer of MBS multicast/broadcast data to the UE over MRB(s);
Network controlled mobility including measurements.

Thus, RRC connected state is used in particular to transmit data, e.g. by using data packets, wherein a data packet may include at least one of data, unicast data, multicast data, broadcast data, TB, CB, CBG, etc.

For multicast service, gNB may deliver Multicast MBS data packets using the following methods:
PTP Transmission: gNB individually delivers separate copies of MBS data packets to each UEs independently, i.e., gNB uses UE-specific PDCCH with CRC scrambled by UE-specific RNTI (e.g., C-RNTI) to schedule UE-specific PDSCH which is scrambled with the same UE-specific RNTI.
PTM Transmission: gNB delivers a single copy of MBS data packets to a set of UEs, e.g., gNB uses group-common PDCCH with CRC scrambled by group-common RNTI to schedule group-common PDSCH which is scrambled with the same group-common RNTI (see e.g. section 16.10.5.4).

Further, a CFR configured by RRCReconfiguration message is defined for multicast scheduling as an ‘MBS frequency region’ with a number of contiguous PRBs confined within and with the same numerology as the DL BWP, and multicast scheduling may have specific characteristics (e.g., PDCCH, PDSCH and SPS configurations).

Two HARQ-ACK reporting modes are defined for MBS:
For the first HARQ-ACK reporting mode, the UE generates HARQ-ACK information with ACK value when a UE correctly decodes a transport block or detects a DCI format indicating an SPS PDSCH release; otherwise, the UE generates HARQ-ACK information with NACK value.
For the second HARQ-ACK reporting mode, the UE does not transmit a PUCCH that would include only HARQ-ACK information with ACK values.

HARQ-ACK feedback for multicast can be enabled or disabled by higher layer configuration per G-RNTI or per G-CS-RNTI and/or indication in the DCI scheduling multicast transmission, see e.g. section 16.10.5.7.

Thus, gNB is configured to enable HARQ-ACK feedback for multicast, together with the enablement the assistance information may be configured as well. E.g. a new HARQ-ACK reporting mode is added, in which the UE generates HARQ-NACK information with assistance information when a UE incorrectly decodes a transport block (failed TB), or failed CB, or failed CBG.

Further, in general HARQ ACK feedback may be configured to be transmitted using PUCCH or PUSCH. E.g. the IE BWP-UplinkDedicated is used to configure the dedicated (UE specific) parameters of an uplink BWP. (see e.g. 3GPP TS 38.331 V17.3.0 (2022-12) section 6.3.2 Radio resource control information element-BWP-Uplink dedicated). In pucch-ConfigurationListMulticast2 PUCCH configurations for two simultaneously constructed NACK-only feedback for MBS multicast (see TS 38.213, clause 9) can be configured, thus NACK-only feedback on PUCCH. The NACK feedback may be extended to include also the assistance information to be transmitted from the UE on the PUCCH, e.g. to support the network node to better select an appropriate transmission for e.g. re-transmission of a failed data packet, TB, CB, etc. Such configuration may e.g. be added to MAC-CellGroupConfig The IE MAC-CellGroupConfig is used to configure MAC parameters for a cell group, including DRX. includes e.g. harq-FeedbackEnablerMulticast-r17 ENUMERATED {dci-enabler, enabled} OPTIONAL, —Need and harq-FeedbackOptionMulticast-r17 ENUMERATED {ack-nack, nack-only} OPTIONAL, —Cond HARQFeedback, and may further include assistance configuration.

E.g. according to 3GPP TS 38.300 V17.3.0 (2022-12) section 10.3 Uplink Scheduling is exemplarily described,

In the uplink, the gNB can dynamically allocate resources to UEs via the C-RNTI on PDCCH(s). A UE always monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission.

In addition, with Configured Grants, the gNB can allocate uplink resources for the initial HARQ transmissions and HARQ retransmissions to UEs.

Such allocated resources may then be used to transmit the assistance information as well.

E.g. according to 3GPP TS 38.300 V17.3.0 (2022-12) section 5.2.5.4

Asynchronous Incremental Redundancy Hybrid ARQ is supported. The gNB provides the UE with the HARQ-ACK feedback timing either dynamically in the DCI or semi-statically in an RRC configuration. Retransmission of HARQ-ACK feedback is supported by using enhanced dynamic codebook and/or one-shot triggering of HARQ-ACK transmission for (i) all configured CCs and HARQ processes in the PUCCH group, (ii) a configured subset of CCs and/or HARQ processes in the PUCCH group, or (iii) a dynamically indicated HARQ-ACK feedback instance. For HARQ-ACK of SPS PDSCH without associated PDCCH, in case of HARQ-ACK dropping due to TDD specific collisions, the HARQ-ACK feedback can be deferred to a next available PUCCH transmission occasion.

The UE may be configured to receive code block group based transmissions where retransmissions may be scheduled to carry a sub-set of all the code blocks of a TB.

The UE may in addition to the HARQ-ACK feedback also be configured related to the assistance information, The configuration can e.g. include at least one of the following timing, content, periodicity, applicability to a subset of failed CBs NACKs (e.g. transmit assistance information only for the first failed CB of a TB, e.g. as assistance information means additional overhead, which should be kept small, and as the content of the assistance information for multiple failed CBs of a TB might be identical due to same SNR signals measurements available).

Such a UE may then be implemented in the environment of FIGS. 2 and 3.

In a further embodiment the assistance information capability might be added to the UE capabilities. E.g. according to 3GPP TS 38.300 V17.3.0 (2022-12) section 7.5 The UE reports its UE radio access capabilities which are static at least when the network requests. The gNB can request what capabilities for the UE to report based on band information. The UE capability can be represented by a capability ID, which may be exchanged in NAS signalling over the air and in network signalling instead of the UE capability structure.

More details on how the UE compiles and transfers its UE capability information upon receiving a UECapabilityEnquiry from the network are e.g. described in section 5.6. The network initiates the procedure to a UE in RRC_CONNECTED when it needs (additional) UE radio access capability information.

The may request from the UE assistance information support indication if the UE is in delay sensitive communication, such as XR or ultra reliable-low latency communications (URLLC). In this case UE shall set the contents of UECapabilityInformation message to include its capability to support assistance information in case of HARQ. This way the gNB is enabled to configure the assistance information generation and provision, e.g. dependent on the radio conditions, e.g. in bad conditions it might be beneficial to receive customized assistance information to increase throughput and ensure reliability. The UE may then, e.g. in case of a failed TB reception, propose to the gNB a better suited transmission parameter to be used in retransmitting the failed TB. The UE is in an advantageous position to calculate a suitable transmission parameter based on Signal-to-Interference plus Noise Ratio, SINR, measurements performed by the UE. The suitable, adapted transmission parameter or information related thereto is then transmitted to the gNB together with the NACK signal which represents a fast feedback, and enables the gNB to quickly adjust the retransmission of the failed TB, but potentially also other transmissions, e.g. transmissions of new TBs and/or new CBs, such that not only the failed TB can be quickly recovered, but also the successful decoding of newly received TBs is increased.

A User Equipment, UE, may be configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a UE capability request,
send, towards the network node, a UE capability information including the UE's capability to support sending assistance information in case of detecting a failure in decoding a received data packet, wherein a data packet, in particular, includes a Transport Block, TB, and/or a Code Block, CB,
receiving, from the network node, a configuration message including, in case the UE supports sending the assistance information, a configuration related to the use of the assistance information,
in case of detecting a failure in the decoding of a received data packet, prepare an associated assistance information based on the configuration,
transmit, towards the network node, information for indicating the detected failure and the associated assistance information for enabling the network node to trigger actions related to the failed data packet based on the assistance information,
wherein the UE is further configured to include information related to at least one transmission parameter different from a corresponding transmission parameter used for the transmission of the failed data packet in the assistance information.

### List of Abbreviations

5QI 5G QoS Identifier
ACK Acknowledgement
ARQ Automatic repeat request
BLER Block error rate
CB Code block
CBG Code block group
DL Downlink
HARQ Hybrid ARQ
IE Information Element
LA Link adaptation
MAC Medium access control
MCS Modulation and coding scheme
NDI New data indicator
NACK Negative ACK
PDB Packet delay budget
PDSCH Physical downlink shared channel
RB Radio Bearer
RE Resource element
RRC Radio resource control
TB Transport block
TBS TB size
TSC Time sensitive communication
UE User equipment
UL Uplink
URLLC Ultra reliable low latency communication
QoS Quality of service
XR extended Reality

1-27. (canceled)

28. A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a Transport Block, TB;
carry out a Cyclic Redundancy Check, CRC, for decoding the received TB;
in case of detecting a failure in the decoding by determining that the received TB fails the CRC check, prepare an assistance information,
transmit towards the network node information for indicating the failure and the assistance information for enabling the network node to trigger actions related to the failed TB based on the assistance information,
wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE, wherein one transmission parameter is related to rank, and
wherein the UE is further configured to include information related to at least one determined different transmission parameter in the assistance information.

29. The UE according to claim 28, wherein a transmission parameter is related to at least one of number of retransmissions, Modulation and Coding Scheme, MCS, New Data Indicator, NDI, type of redundancy, redundancy algorithm, rank.

30. The UE according to claim 29, wherein the transmission parameter is related to number of retransmissions, MCS and NDI, and the UE is further caused to:
indicate the network node, via the assistance information, to carry out the calculated estimated number of required retransmissions with an initial MCS used for the failed transmission of the TB,
wherein the NDI indicates that a copy of the failed transmission of the TB is to be transmitted by the network node.

31. The UE according to claim 29, wherein the transmission parameter is related to number of retransmissions, MCS and NDI, and the UE is further caused to:
based on a preconfigured function, determine a number of required retransmissions to be carried out by the network node with a target MCS different from an initial MCS used for the failed transmission of the TB,
wherein the preconfigured function comprises input parameters including a decoding analysis result, the initial MCS and the target MCS, wherein the UE is configured to determine the decoding analysis result based on the SINR measurements; and
indicate the network node, via the assistance information, to carry out the determined number of required retransmissions with the target MCS,
wherein the NDI indicates that a copy of the failed transmission of the TB is to be transmitted by the network node.

32. The UE according to claim 29, wherein the transmission parameter is related to number of retransmissions, NDI and at least one of MCS, type of redundancy and redundancy algorithm, wherein the UE is configured with a maximum allowed number of retransmissions, and the UE is further caused to:
if the calculated estimated number of required retransmissions of the failed TB exceeds the maximum allowed number of retransmissions, indicate the network node, via the assistance information, to carry out a new transmission for the failed TB with a new type of redundancy different from an initial type of redundancy used for the failed transmission of the TB and/or with a new MCS different from an initial MCS used for the failed transmission of the TB and/or with a new redundancy algorithm different from an initial redundancy algorithm used for the failed transmission of the TB,
wherein the NDI indicates that new data related to the failed TB is to be transmitted by the network node.

33. The UE according to claim 29, wherein the transmission parameter is related to rank and NDI, and the UE is further caused to:
based on a decoding analysis result related to the failed TB, the decoding analysis result comprising the SINR measurements, determine a new rank different from an initial rank used for the failed transmission of the TB, and indicate the network node, via the assistance information, to carry out transmission with the determined new rank; or
indicate the network node, via the assistance information, to determine a new rank different from and preferably lower than the initial rank and to carry out transmission with the determined new rank,
wherein a rank indicates a number of streams of data to be received with the same number of receiving antennas at the UE,
wherein the NDI indicates either new data related to the failed TB to be transmitted by the network node or a copy of the failed transmission of the TB to be transmitted by the network node.

34. The UE according to claim 29, wherein the UE is further caused to:
measure an SINR value for the received and failed TB;
calculate a difference between a preset decodable SINR value and the measured SINR value; and
based on the calculated difference value, calculate the estimated number of required retransmissions of the failed TB by the network node.

35. The UE according to claim 29, wherein the received TB comprises a plurality of Code Block Groups, CBGs, wherein the UE is further caused to:
if determining that at least one of the plurality of CBGs fails the CRC check, determine that the received TB fails the CRC check; and
transmit the assistance information to the network node for the at least one failed CBG.

36. A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a Transport Block, TB;
carry out a Cyclic Redundancy Check, CRC, for decoding the received TB;
in case of detecting a failure in the decoding by determining that the received TB fails the CRC check, prepare an assistance information,
transmit towards the network node information for indicating the failure and the assistance information for enabling the network node to trigger actions related to the failed TB based on the assistance information,
wherein the UE is further configured to, in case of detecting the failure, determine at least one transmission parameter based on Signal-to-Interference plus Noise Ratio, SINR, measurements performed by the UE, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE, and
wherein the UE is further configured to include information related to at least one determined different transmission parameter in the assistance information, wherein the assistance information comprises an information element comprising two bits indicating four cases

37. The UE according to claim 36, wherein:
in a first case, the two bits indicate an Acknowledgement, ACK, to the network node, a successful decoding of the received TB and that no retransmissions of the received TB are required;
in a second case, the two bits indicate that one retransmission is required for the failed TB;
in a third case, the two bits indicate that a number of required retransmissions for the failed TB is smaller than or equal to a maximum number of allowed retransmissions for the failed TB allowed at the UE; and
in a fourth case, the two bits indicate a new transmission for the failed TB.

38. A network node of a radio access network, configured to support a hybrid automatic repeat request, HARQ, process when communicating with a User Equipment, UE, the network node comprising:
at least one processor, and
at least one memory storing instructions that, when executed by the at least one processor, cause the network node at least to:
establish a connection towards the UE;
transmit, to the UE, a transport block, TB;
receive, from the UE, information for indicating a failure in decoding the TB at the UE and an associated assistance information prepared by the UE, wherein the assistance information includes information related to a transmission parameter different from a corresponding transmission parameter used for the transmission of the failed TB and
trigger actions related to the failed TB based on the assistance information for supporting successful decoding of said TB at the UE, wherein the assistance information indicates to carry out transmission for the failed TB with a new rank different from an initial rank used for the failed transmission of the TB, wherein the network node is further caused to:
carry out transmission for the failed TB with the new rank, or
select a modified new rank with an index lower than the indicated new rank and carry out transmission for the failed TB with the modified new rank.

39. The network node according to claim 38,
wherein the network node is further caused to transmit to the UE a resource radio control, RRC, message for configuring the assistance information and for indicating the UE to send to the network node the assistance information in case of a failure in decoding the TB at the UE.

40. The network node according to claim 38, wherein the network node is configured to perform transmission related to the failed TB with at least one transmission parameter indicated by the UE via the assistance information, wherein at least one determined transmission parameter is different from a corresponding transmission parameter used for the transmission of the failed TB, and wherein one transmission parameter is, in particular, related to a calculated estimated number of retransmissions required for a successful decoding of said TB at the UE.

41. The network node according to claim 38, wherein a transmission parameter is related to at least one of number of retransmissions, Modulation and Coding Scheme, MCS, New Data Indicator, NDI, type of redundancy, redundancy algorithm, rank.

42. The network node according to claim 38, wherein the assistance information indicates to carry out a calculated estimated number of retransmissions for the failed TB with an initial Modulation and Coding Scheme, MCS, used for the failed transmission of the TB, wherein the network node is further caused to:
if determining that a time needed for carrying out the calculated estimated number of retransmissions does not exceed a preset delay budget, carry out the estimated number of retransmissions for the failed TB with the initial MSC.
